(19) United States
(12) Patent Application Publication
(10) Pub. No.: US 2025/0316096 A1
(43) Pub. Date: Oct. 9, 2025

(54) DEVICES, SYSTEMS, AND METHODS FOR THREE-DIMENSIONAL HUMAN-MACHINE PAIRED ANNOTATION

(71) Applicant: SYNTHETIK APPLIED TECHNOLOGIES, LLC, Austin, TX (US)

(72) Inventor: Wesley Welch, Brandon, MS (US)

(21) Appl. No.: 19/169,859

(22) Filed: Apr. 3, 2025

Related U.S. Application Data
(60) Provisional application No. 63/574,747, filed on Apr. 4, 2024.

(51) Int. Cl. G06V 20/64; G06V 10/44; G06V 10/762; G06V 10/764

(52) U.S. Cl. CPC G06V 20/64; G06V 10/457; G06V 10/763; G06V 10/764; G06V 2201/05

(57) ABSTRACT

Devices, systems, and methods for three-dimensional human-machine paired annotation are disclosed herein. The human-machine paired annotation devices, methods, and systems scan articles housing three-dimensional objects, localize such objects, classify such objects, and generate an estimation of the characteristics of such objects. This estimation provides human users with a reasonable approximation of objects' characteristics to drastically reduce the time required to annotate object characteristics, as well improve the accuracy of those annotations.

### REFERENCE TO RELATED APPLICATION

The present application claims priority to U.S. Provisional Patent Application No. 63/574,747 to Welch, entitled “Devices, Systems, and Methods for Three-Dimensional Human-Machine Paired Annotation,” filed on Apr. 4, 2024, the entirety of which is fully incorporated by reference herein.

### STATEMENT OF GOVERNMENT INTEREST

This invention was made with Government support under Contract Nos. 70RSAT19T00000016, 70RSAT20T00000021, 70RSAT21T00000015, and 70RSAT22T00000016 awarded by the United States Department of Homeland Security. The Government has certain rights in the invention.

### BACKGROUND OF THE DISCLOSURE

### Field of the Disclosure

This disclosure generally relates to devices, systems, and methods for annotating objects in three-dimensional space by x-ray scanning, localizing, and classifying objects. More particularly, this disclosure pertains to localizing, classifying, and identifying objects in bags, sacks, packs, containers, backpacks, luggage, and other similar items, particularly in the security context, including for use in, for example, airports, sporting events, courthouses, and postal services.

### Description of the Related Art

Various governmental agencies and private organizations are tasked with ensuring safe travel and commerce. In an effort to provide adequate safety, these agencies and organizations continually enhance their technological capabilities. These capabilities currently include metal detectors, millimeter wave 360° security screening, and x-ray CT scanners. These technologies are used to identify hidden or concealed weapons, sharp objects, flammable or explosive materials, and other objects that could jeopardize safety. Non-limiting examples include knives, firearms, contraband, explosives, and explosive-making material. The output from each of devices that scan bags and other articles can be inspected by authorized personnel who are trained in the identification of such dangerous objects. However, efforts by the respective agencies and organizations are very costly and require significant resources and human intervention. Due to privacy concerns with millimeter wave imaging on the human body, manual human inspection of these images is prohibited, and inspection is therefore entirely automated.

### SUMMARY OF THE DISCLOSURE

According to one embodiment of the present disclosure, a method of identifying three-dimensional objects located inside an article is disclosed. The method of identifying three-dimensional objects located inside an article includes (1) generating a scan of the article and the objects; (2) identifying density centers of the objects; (3) localizing the objects using the density centers to determine where the objects are within the article and generate localized objects; and (4) classifying the localized objects. The classifying step includes outputting an estimated annotation of the characteristics of the localized objects.

According to another embodiment according to the present disclosure, a method of locating objects in three-dimensional space is provided. The method of locating objects in three-dimensional space includes (1) scanning one or more objects to obtain an array of density values of the one or more objects; (2) identifying one or more density centers in the one or more objects; and (3) performing a connected components analysis, using the one or more density centers as seeds.

According to yet another embodiment according to the present disclosure, a three-dimensional human-machine paired annotation system is provided. The three-dimensional human-machine paired annotation system includes a scanner configured to generate a scan of three-dimensional objects and a non-transitory computer-readable storage medium storing instructions. The instructions, when executed by one or more processors, cause performance of operations including (1) localizing the objects; (2) classifying the objects; and (3) outputting an estimated annotation of the objects. The three-dimensional human-machine paired annotation system further includes one or more processors configured to carry out the instructions stored on the non-transitory computer-readable storage medium.

### BRIEF DESCRIPTION OF THE DRAWINGS

The present disclosure is further described in the detailed description which follows, in reference to the noted plurality of drawings, by way of non-limiting examples of embodiments of the present disclosure, in which like characters represent like elements throughout the several views of the drawings.

FIG. 1 illustrates a representation of an article containing objects that may be scanned and annotated according to one embodiment of the present disclosure;

FIG. 2 illustrates a flowchart of one embodiment of a method for creating an annotated dataset of three-dimensional objects according to the present disclosure;

FIG. 3 illustrates the step of object localization according to the method of FIG. 2;

FIG. 4 illustrates the step of object classification according to the method of FIG. 2;

FIG. 5 illustrates a flowchart depicting steps comprising object localization according to the method of FIG. 2;

FIGS. 6A-6E illustrate various views of a baggage scan according to one embodiment of the present disclosure;

FIGS. 7A-7D illustrate various views of a human-viewable object mesh according to one embodiment of the present disclosure;

FIG. 8 shows a flowchart depicting steps comprising object classification according to the method of FIG. 2;

FIG. 9 depicts a point cloud according to the “generate point clouds” step of the flowchart of FIG. 8;

FIGS. 10A and 10B illustrate graphical user interfaces according to an embodiment of the present disclosure;

FIG. 11 depicts a voxel mask object prediction according to one embodiment of the present disclosure;

FIG. 12 illustrates a flowchart depicting a method of handling unknown objects according to the present disclosure; and

FIG. 13 illustrates a user interface for confirmation or denial of potential object class matches according to the flowchart of FIG. 12.

### DESCRIPTION OF THE DISCLOSURE

In the following detailed description, numerous specific details are set forth in order to provide a more thorough understanding of embodiments incorporating features of the present disclosure. However, it will be apparent to one skilled in the art that devices and methods according to the present disclosure can be practiced without necessarily being limited to these specifically recited details.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

Throughout this disclosure, the embodiments illustrated and the components therein, including, but not limited to, specific microcontrollers, power sources, and sensors, should be considered as exemplars, rather than as limitations on the present disclosure. As used herein, the term “composition,” “device,” “structure,” “method,” “system,” “disclosure,” “present composition,” “present device,” “present structure,” “present method,” “present system,” or “present disclosure” refers to any one of the embodiments of the disclosure described herein, and any equivalents. Furthermore, reference to various feature(s) of the “composition,” “device,” “structure,” “method,” “system,” “disclosure,” “present composition,” “present device,” “present structure,” “present method, “present system,” “present apparatus,” or “present disclosure” throughout this document does not mean that all claimed embodiments or methods must include the reference feature(s).

Furthermore, any element in a claim that does not explicitly state “means for” performing a specified function, or “step for” performing a specific function, is not to be interpreted as a “means” or “step” clause as specified in 35 U.S.C. § 112, for example, in 35 U.S.C. § 112(f) or pre-AIA 35 U.S.C. § 112, sixth paragraph. In particular, the use of “step of” or “act of” in the claims herein is not intended to invoke the provisions of 35 U.S.C. § 112.

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Furthermore, relative terms such as “left,” “right,” “front,” “back,” “top,” “bottom'” “forward,” “reverse,” “clockwise,” “counter-clockwise,” “outer,” “inner,” “above,” “upper,” “lower,” “below,” “horizontal,” “vertical,” and similar terms, have been used for convenience purposes only and are not intended to imply any particular fixed direction. Instead, they are used to describe a relationship of one element to another. Terms such as “higher,” “lower,” “wider,” “narrower,” and similar terms, may be used herein to describe angular relationships. It is understood that these terms are intended to encompass different orientations of the elements or system in addition to the orientation depicted in the figures.

Although ordinal terms, e.g., first, second, third, etc., may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments as described in the present disclosure can be described herein with reference to view illustrations that are schematic in nature. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region and are not intended to limit the scope of the disclosure. Further, it is understood that, while embodiments of the present disclosure comprise various shapes, these shapes are not exhaustive, and other shapes are possible.

It is understood that when a first element is referred to as being “between” or “interposed between” two or more other elements, the first element can be directly between the two or more other elements or intervening elements may also be present between the two or more other elements. For example, if a first element is “between” or “interposed between” a second and third element, the first element can be directly between the second and third elements with no intervening elements, or the first element can be adjacent to one or more additional elements with the first element and these additional elements all between the second and third elements.

### I. Contemporary Three-Dimensional Object Data Annotation

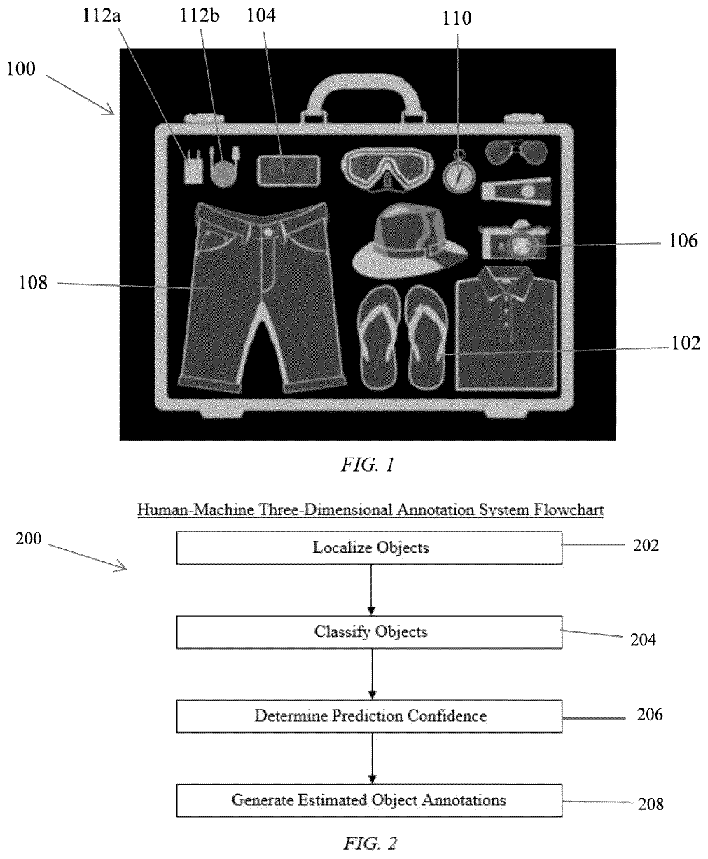

FIG. 1 shows a representation of a scan of an article 100 with a variety of objects inside, such as flip flops 102, a smart phone 104, a camera 106, shorts 108, a pocket watch 110, and a phone charger 112a, 112b. Presently, to promote traveler safety, the interior of travelers' luggage and/or baggage is x-ray scanned. The datasets obtained from scans of objects therein can then be annotated, i.e. labeled such that a camera is annotated as a “camera,” a smart phone is labeled as a “smart phone,” and so on.

These annotated datasets may then be used by, for example, baggage scanning manufacturers, to ensure banned and/or dangerous items or substances are detected by security personnel. The current standard for annotating objects in three dimensions (“3D”) is 100% human annotation, whereby an individual or a collection of individuals is tasked with labeling and identifying objects in a complex 3D scene (i.e. a collection of 3D objects in a 3D environment). This is a time-consuming, mentally demanding task that is prone to errors.

The current standard for 3D object annotation requires significant human involvement in the annotation process because automated threat recognition algorithms, a potential annotation automation, still require tens of thousands of examples to train the algorithms. This still requires human annotator input. The cognitive load on human annotators can be overwhelming, given the sheer volume of data that must be annotated, coupled with the need for precise, consistent labeling. This cognitive load often leads to inefficiencies and inaccuracies.

### II. Human-Machine Three-Dimensional Object Annotation System

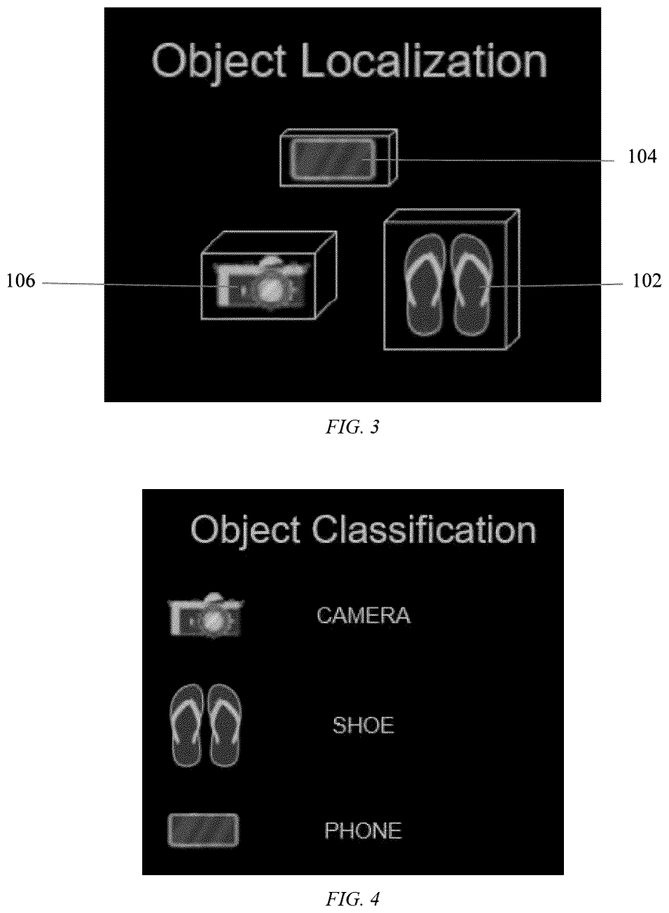

Disclosed herein is a system 200 (referred to herein as a “human-machine three-dimensional annotation system”) for generating estimated characteristic annotations for scanned three-dimensional objects. FIG. 2 depicts a flowchart view of an embodiment of a human-machine three-dimensional annotation system 200. The system 200 generates estimated annotations of 3D object characteristics by (1) localizing objects 202 (i.e. ascertaining the objects and where they are), (2) classifying objects 204 (i.e. determining what objects are), and, in some embodiments, (3) determining a prediction confidence 206, and (4) outputting estimated object annotations 208. These estimated object characteristics can then be reviewed by a human with increased speed and precision relative to 100% human annotation of 3D objects. With reference to FIGS. 3 and 4 as an example, object localization (the first process in the system) determines that the flip-flops 102, smart phone 104, and camera 106 are objects, whereas object classification (the second process in the system) determines that those objects are, in fact, shoes, a phone, and a camera, respectively. FIGS. 3 and 4 are illustrative caricatures of object localization and object classification intended as explanatory tools to describe those steps of the system 200 at a high level. FIGS. 3 and 4 do not necessarily represent a faithful reproduction of the outputs of object localization and object classification.

### A. Object Localization

Machine learning models are often trained on annotated (i.e., labeled) data, the creation of which is particularly tedious in 3D vision. The human-machine three-dimensional annotation system 200 disclosed herein automatically generates estimated three-dimensional object characteristic annotations that can be reviewed and fully annotated by humans faster for subsequent use in machine learning model creation.

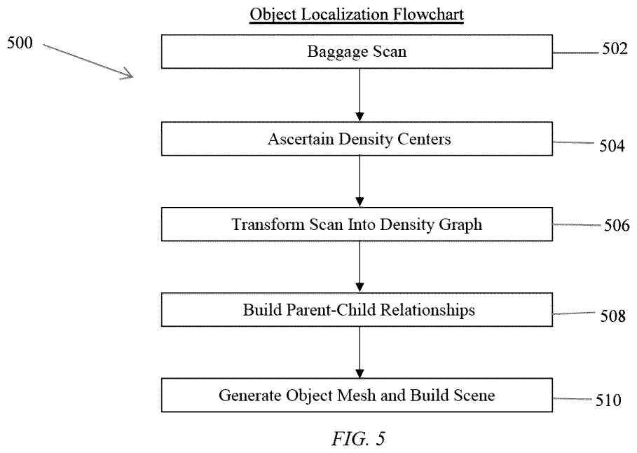

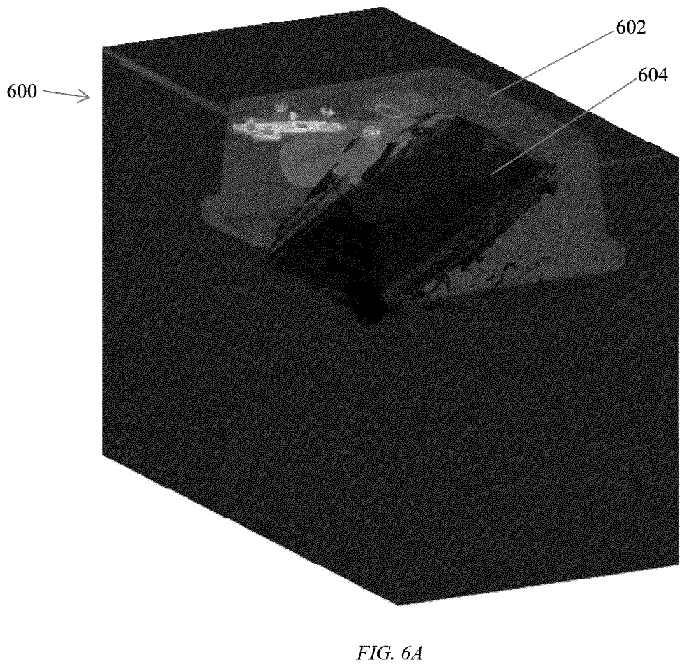

The first step in generating annotation estimations is object localization. FIG. 5 shows a flow chart 500 depicting the steps of object localization, namely: (1) scanning an article 502 (i.e. luggage, a bag, etc.), (2) ascertaining density centers within objects 504, (3) transforming the scan into a density graph and performing a connected components analysis on said density graph 506, (4) applying the intersection over union metric to build parent-child relationships between and among objects, 508 and (5) transforming objects into human-viewable surface meshes 510.

i. Baggage Scan

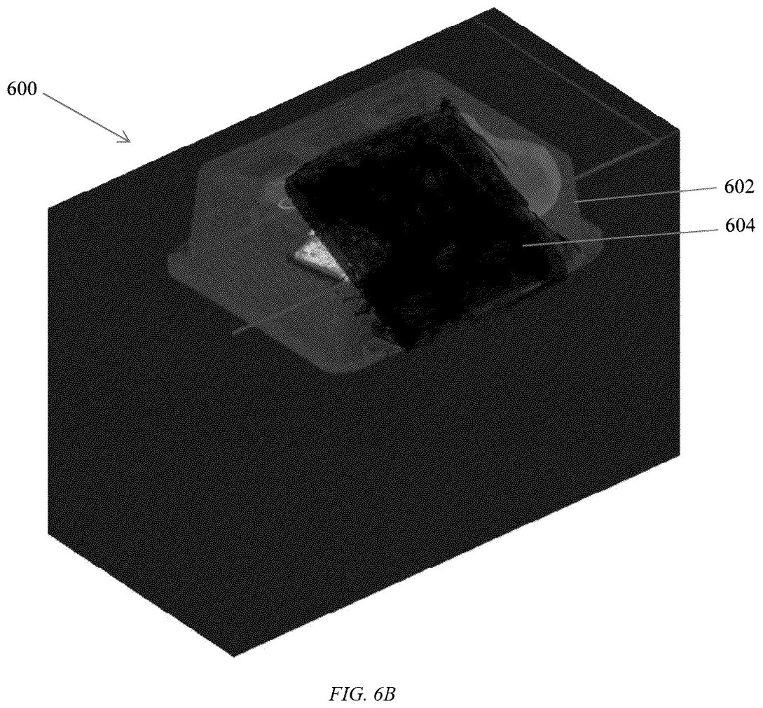

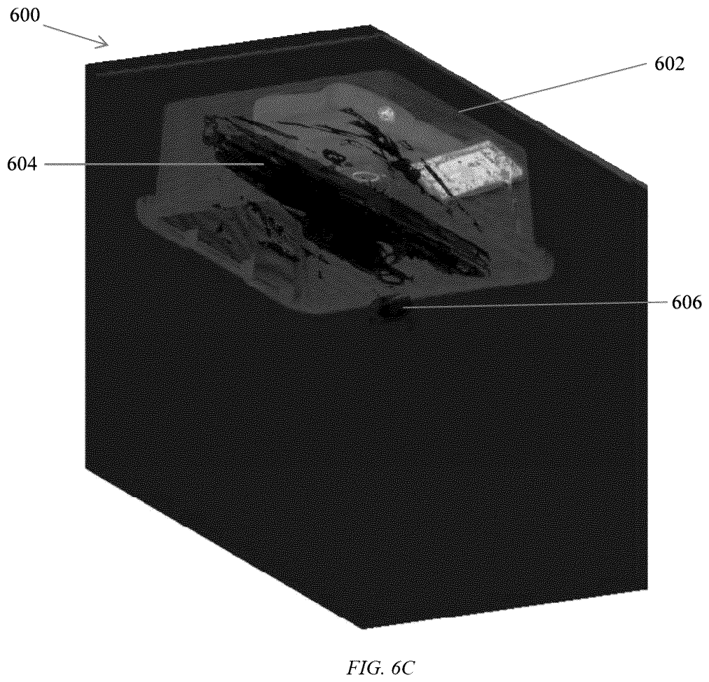

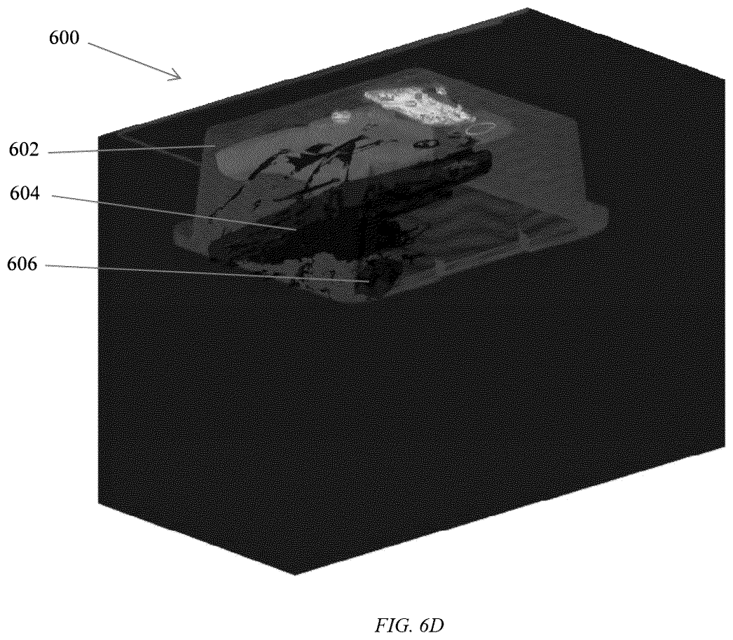

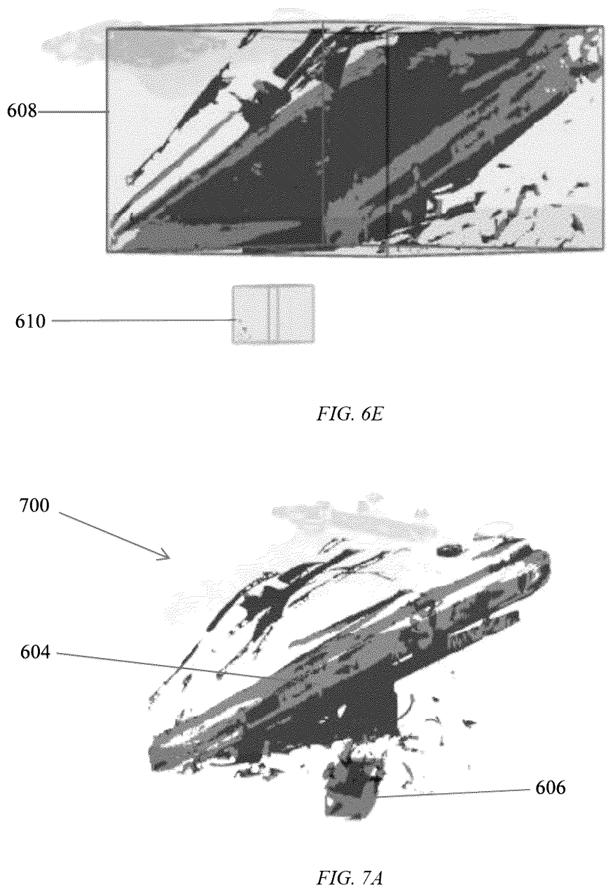

First, the baggage is scanned to reveal its contents. An example baggage scan 600 is depicted in FIGS. 6A-6D. As one of skill in the art would recognize, many different scanning technologies and standards may be used. For instance, and by way of example only, the Digital Imaging and Communication in Security (“DICOS”) standard utilized by the United States Transportation Security Administration (“TSA”) may be utilized to scan baggage 100. Similarly, given that baggage may contain an innumerable amount of objects arranged in countless permutations, it is understood that the example baggage scan 600 is but one of a multitude of possible baggage scans that could be produced by the system 200. In some embodiments, the baggage 100 may be scanned in slices of varying thickness, such as for instance, 1 mm or less, 2 mm or less, 3 mm or less, 4 mm or less, 1 mm or more, 2 mm or more, 3 mm or more, or 4 mm or more.

In some embodiments, the baggage 100 is loaded into a baggage scanner in a container 602, as shown in FIGS. 6A-6D. The example baggage scan 600 contains a laptop 604 and, as shown in FIGS. 6C and 6D, a bottle 606, among other objects not discussed herein for the sake of simplicity. It is understood that an article of baggage 100 may contain many more objects.

Once the baggage is scanned, the resulting baggage scan 600 may be loaded and/or transformed into, for example, a NumPy array for mathematical and other types of operations. It is understood that other array libraries may be used, such as, for instance, TensorFlow, PyTorch, and others known to one of skill in the art. In some embodiments according to the present disclosure, to ensure consistency and comparability across scans, voxel density (i.e. the density of three-dimensional pixels) may be normalized based on parameters from a header file associated with the baggage scan 600. This normalization, in some embodiments according to the present disclosure, may include scaling the baggage scan 600 in the z-direction, aligned with slice thickness. This slice thickness may be determined by the machine that generated the baggage scan 600. In some embodiments, density values may be limited to predetermined bounds. In specific embodiments, density values may be limited to a lower density of −1000 Hounsfield Units (air) (“HU”) and an upper density of 10,000 HU, thereby avoiding outlier densities and creating a more reliable foundation for further analysis.

ii. Density Centers

Thereafter, the human-machine three-dimensional object annotation system 200 may, in some embodiments, identify each object's “density center” 202. A density filter of a particular threshold HU value, for example, 1000 HU or more, can be applied to the baggage scan 600 to eliminate values below a specified threshold. It is understood that the aforementioned threshold value is exemplary in nature and not intended to limit this disclosure. The resulting filtered array may then be normalized, thereby enabling a clustering technique that may reveal key insights. In certain embodiments, the filtered array may be normalized based on discretized density ranges, such as the range of 1,000 HU to 3,250 HU, 3,251 HU to 5,500 HU, 5,501 HU to 7,750 HU, and 7,751 HU to 10,000 HU. One of skill in the art should understand that these density ranges are intended to be exemplary in nature only and not as limiting this disclosure.

In some embodiments according to the present disclosure, the Density-based spatial clustering of applications with noise (“DBSCAN”) algorithm may be used to identify density centers 202 that serve as seed values for subsequent analysis. It is understood that other clustering methods known in the art may be used, such as for example Mean shift, Hierarchical Density-Based Spatial Clustering of Applications with Noise, and others known in the art. In specific embodiments, no or almost no objects are overlooked, as DBSCAN does not require specification of the number of clusters present, unlike other clustering techniques. This is especially useful for finding small, dense objects which otherwise could be missed.

iii. Density Graph & Connected Components

Next, voxels of the baggage scan 600 may be transformed into a density graph (not pictured in figures, as the density graph is purely a computer calculation) whereby each voxel is assigned a density. A connected components algorithm may then be applied to density graph to obtain sets of interconnected subgraphs in three-dimensional space. These subgraphs are created when there is a path (regardless of edge direction) between voxel nodes in the density graph. As discussed above with respect to density center acquisition, in some embodiments, density is segmented and quantized into distinct ranges, which aids in discovering structures within a density graph.

Some embodiments of the present disclosure use the density centers 202 as seed values from which connected components may be ascertained. In specific embodiments, voxels adjacent to and/or nearby density centers 202 may be evaluated as potential constituents of the same object. For example, voxels touching density centers 202 that have the same or similar density may be considered to be part of the same object. Then, other voxels touching voxels comprising the same object may be evaluated. Use of density centers 202 reduces processing time, as noisy connected components, e.g. several air voxels next to one another, are discarded. Additionally, smaller, denser objects, such as small metal components, are more easily recognized when density centers 202 are used as seed values for a connected components analysis.

iv. Parent-Child Relationships

The human-machine three-dimensional object annotation system 200 may, in some embodiments, build parent-child relationships among the connected components of an object 508. By way of example, a scanned object may be a shoe comprising a sole, side walls, and shoe laces. In this example, the parent object would be the shoe, and the children objects would be the sole, side walls, and shoe laces. Some embodiments employ the intersection over union (“IOU”) metric to determine whether objects discovered through the connected components algorithm are separate, parts of the same entity, or nested within each other. By establishing parent-child relationships, objects may be separated and classified in subsequent steps of the human-machine three-dimensional object annotation system 200.

As shown in FIG. 6E, in some embodiments according to the present disclosure, the human-machine three-dimensional object annotation system 200 may generate bounding boxes or bounding cubes 608, 610 (discussed in more detail below) around objects. In more specific embodiments, the IOU metric may be applied to the bounding boxes 608, 610 to ascertain whether they intersect, and if so, the extent to which they intersect. In some embodiments, bounding boxes 608, 610 that intersect a predetermined number of times, over a predetermined volume, or a combination of both thresholds may be treated as the same object, parts of the same object, or nested objects.

v. Object Mesh Generation and Scene Building

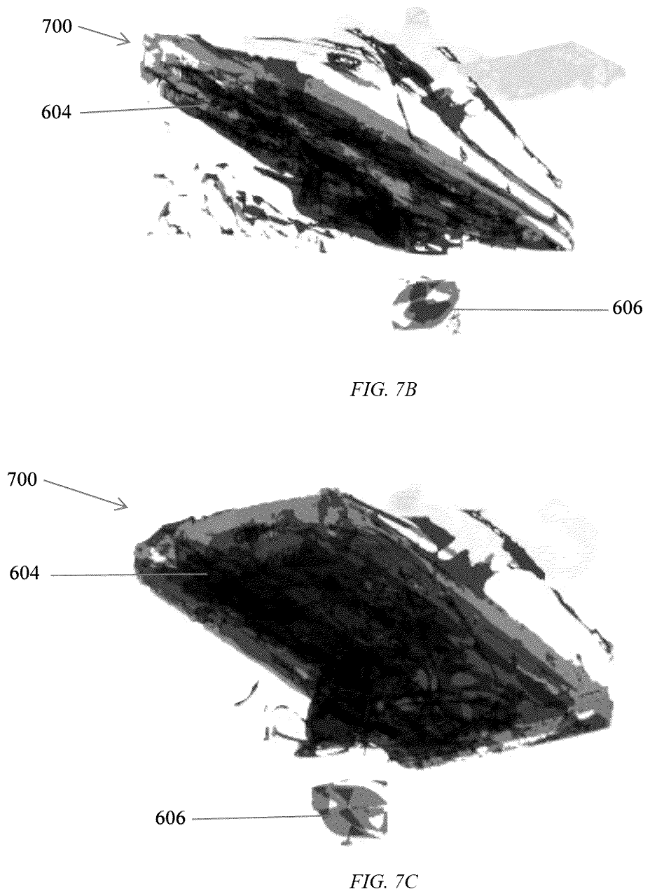

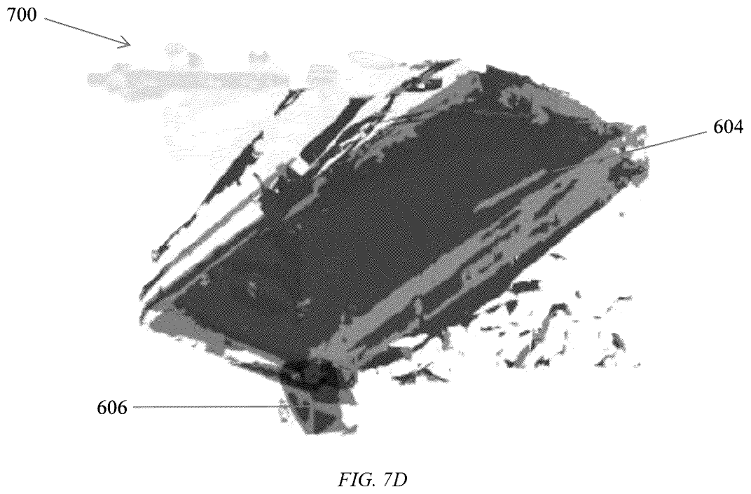

In some embodiments, because human annotators ultimately review t of the human-machine three-dimensional object annotation system 200, the processed (i.e. post-parent-child relationship building) baggage scan 600 is transformed 510 into a human-viewable object mesh 700, as depicted in FIGS. 7A-7D. In more specific embodiments, the discrete marching cubes algorithm is used to transform segmented objects into surface meshes 700, which are then integrated into, for example, a .gltf file. It is understood that other three-dimensional file formats are feasible. The surface mesh 700 provides human annotators with an interactive, visual representation of the scanned objects. This visualization empowers users to easily interact with and validate or revise annotated objects. As shown in FIGS. 7A-7D, the laptop 604 and the bottle 606 are visually represented as object meshes. In certain embodiments, bounding boxes or cubes are generated around objects, which are then classified (as discussed in detail below).

In some embodiments according to the present disclosure, localization ends with the creation of an object voxelization for each object in its entirety. Object voxelization involves reverse engineering the voxels of recombined objects from the parent-child relationships established earlier. In doing so, each voxel within an object is assigned the same class for classification, improving the accuracy of subsequent machine-assisted annotation processes.

### B. Object Classification

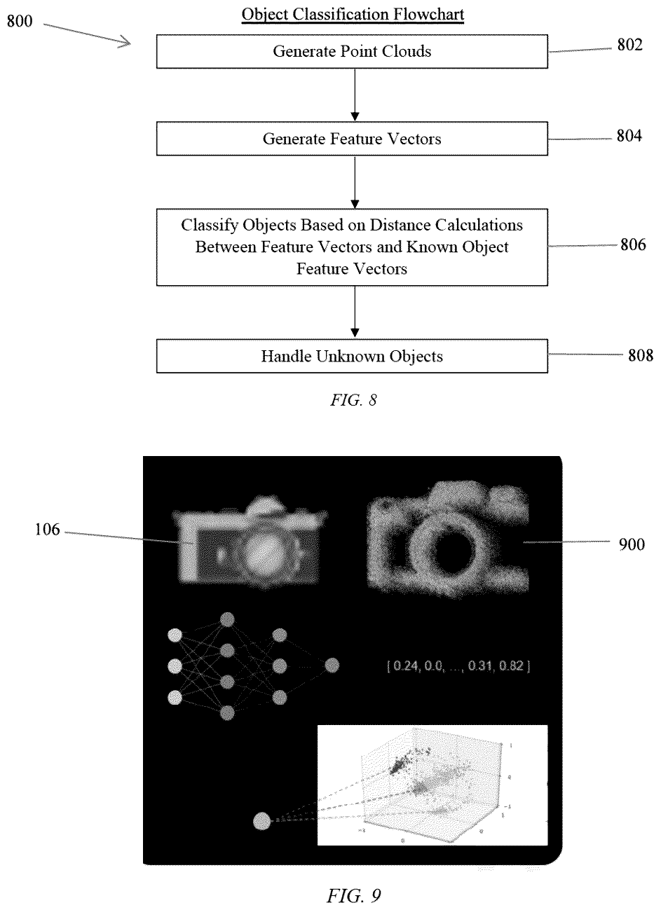

Another aspect of the human-machine three-dimensional object annotation system 200 is object classification, i.e. what an object is. In some embodiments, and as depicted in the object classification flow chart 800 of FIG. 8, object classification involves (1) generating a point cloud for objects 802, (2) generating feature vectors from said point clouds 804, (3) classifying objects based on distance calculations between said feature vectors and known object feature vectors 806, (4) and handling unknown objects 808.

i. Point Cloud Generation

In some embodiments according to the present disclosure, the first step of object classification is the generation 802 of point clouds 900. For instance, a camera 106 produces the specific point cloud 900 shown in FIG. 9. The point cloud 900 may be randomly sampled from a scanned object's (e.g., the camera 106) voxel representation created at the end of the localization step, and may encode essential geometric information. Each point cloud 900 is a unique representation for a particular object, and captures the unique combination of voxels that define the object's identity. These point clouds 900 pave the way for feature generation, discussed below.

ii. Feature Generation

Following the step of generating point clouds 802, the human-machine three-dimensional object annotation system 200 generates feature vectors using machine learning. These feature vectors hold the essence of each object, and can be thought of as a fingerprint for each object, representing its unique characteristics that the classification system can use.

In some embodiments according to the present disclosure, feature generation may be accomplished via a few-shot learning algorithm. Few-shot learning is a machine enables learning framework that a pre-trained model to generalize characteristics with limited data, thereby reducing the number of objects required to establish a classification. In certain embodiments, the few-shot learning algorithm may be based on a headless model of PointNet, pre-trained on an extensive dataset of real-world objects rendered as point clouds 900. In such embodiments, the model possesses a deep understanding of object geometry, enabling it to generate rich feature vectors for the object point clouds 900.

iii. Distance-Based Feature Classification

Once feature generation 804 has occurred, distance-based feature classification 806 can be effected. In this step, the distance between the feature vectors obtained above and feature vectors for known objects is calculated. The smaller the distance between the obtained feature vectors and the known objects, the more likely the scanned object is within the same class as the known object.

In some embodiments according to the present disclosure, the Mahalanobis distance algorithm, a multidimensional measure that considers both the distance from the mean and the covariance between feature vectors and class distributions, can be used to calculate distances between feature vectors for known and scanned objects. One benefit of the Mahalanobis algorithm is that it takes variance into account. For instance, the class of shoes will have far more variance than, for example, laptops. Thus, a scanned object that has feature vectors that have, for example, an average distance of 4 from those of a laptop may still be classified as a shoe even though the feature vector average distance may be, for example, 10 from those of a shoe. As a result, the Mahalanobis distance captures subtle variations between object classes, accommodating the diverse nature of objects within a category.

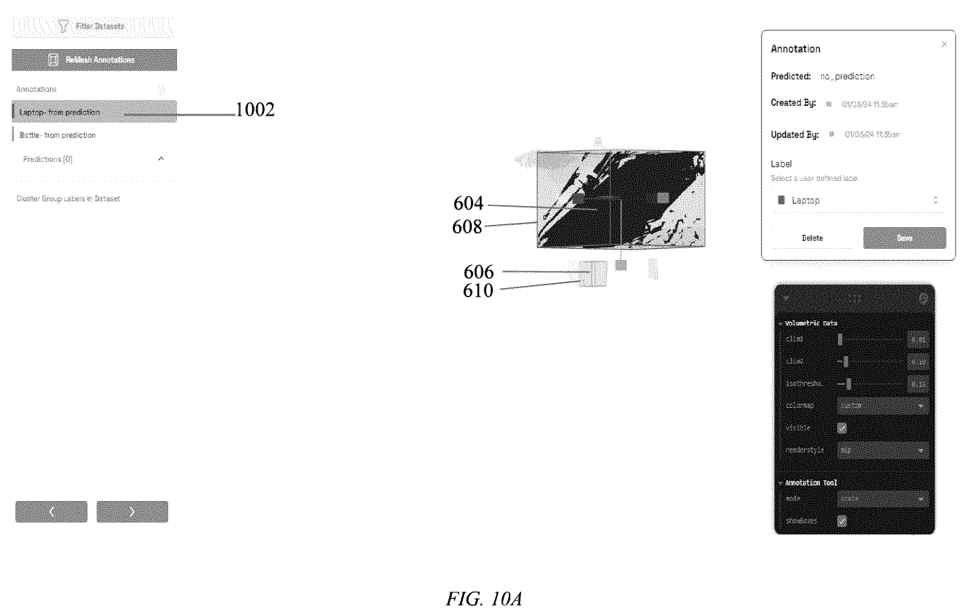

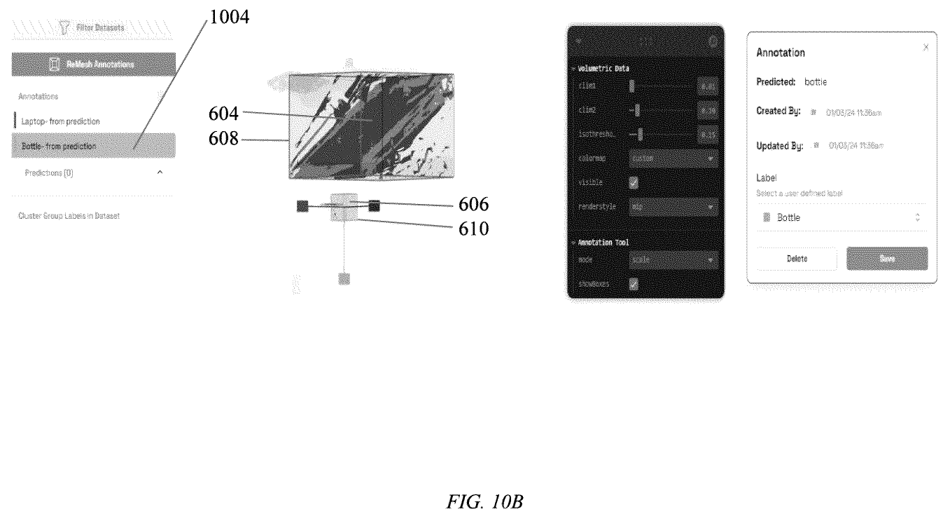

The human-machine three-dimensional object annotation system 200 makes predictions of objects' classifications based on the above-described distance-based feature classification 806. In some embodiments, the human-machine three-dimensional object annotation system 200 may label bounding boxes 608, 610 as the predicted object class. For example, FIGS. 10A and 10B illustrate user interfaces according to the present disclosure containing predictions 1002, 1004 for the laptop 604 and bottle 606 bound in bounding boxes 608, 610, respectively.

iv. Handling Unknown Object Classes

Not all objects may fit neatly into predefined classes. When the human-machine three-dimensional object annotation system 200 is faced with uncertainty, it may, in some embodiments, cluster unknown object classes into groups, with a representative exemplar chosen as the cluster center. Thereafter, a human annotator may review these clustered objects and determine that they belong to a particular class, e.g. socks or toothbrushes. In some embodiments according to the present disclosure, the human annotator can then batch label (discussed in more detail below) all objects in a particular cluster as a particular class.

Some embodiments according to the present disclosure make use of the K-medoids algorithm for clustering to handle uncertainty efficiently. That said, it is understood that other clustering techniques may be used to solve the uncertainty problem, such as K-means, centroid, and others known in the art.

### C. Determination of Confidence in Predictions

Trust and confidence are paramount in any annotation system, including the human-machine three-dimensional object annotation system 200.

i. Voxel Mask Confidence

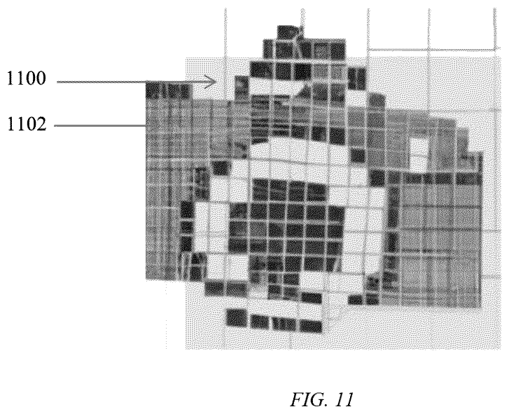

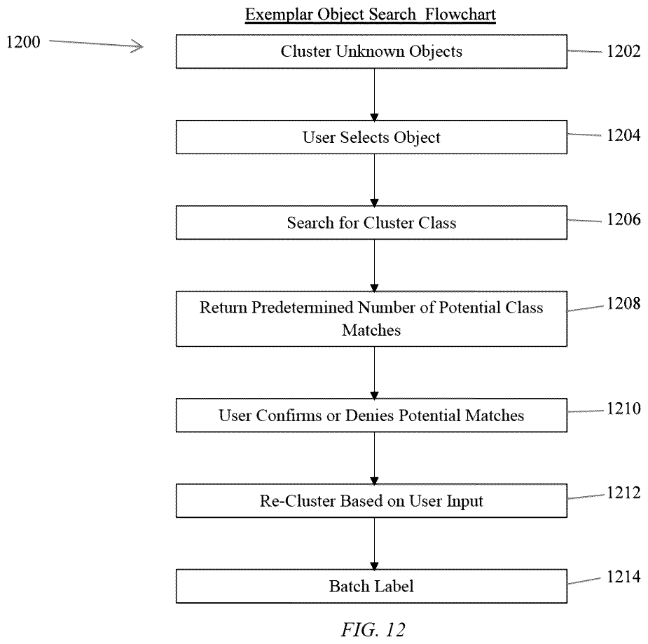

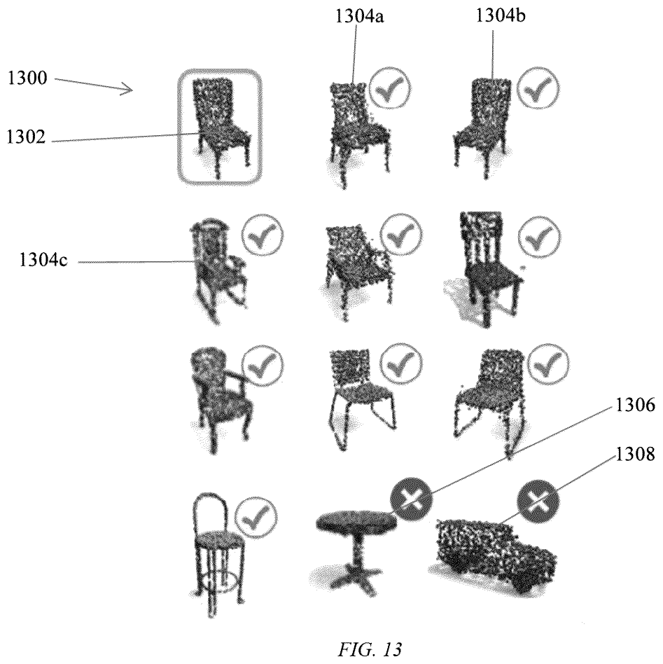

The human-machine three-dimensional object annotation system 200 commences confidence-building with Voxel Mask Confidence. FIG. 11 shows a voxel mask object prediction 1100 according to one embodiment of the present disclosure. To gauge the reliability of voxel mask object predictions 1100, the human-machine three-dimensional object annotation system 200 may, in some embodiments, employ the Sorensen-Dice coefficient, a statistic commonly used in image segmentation tasks. The Sorensen-Dice coefficient measures the similarity between two samples by calculating the overlap between predicted object voxel mask and a ground truth 1102. By quantifying the similarity or differences, insights may be gained into the accuracy of the human-machine three-dimensional object annotation system's 200 predictions.

Similar to Intersection over Union for bounding boxes, the human-machine three-dimensional object annotation system 200 calculates twice the number of elements each set (i.e. the voxel mask object prediction 1100 and the ground truth 1102) has in common and divides by the sum of the elements in each set. This reveals the degree of similarity between a predicted object voxel mask 1100 and other members of that object's class. By quantifying the similarity, the human-machine three-dimensional object annotation system's 200 predictions can be objectively evaluated for accuracy.

ii. Classification Confidence

Beyond voxel masks, the human-machine three-dimensional object annotation system 200 also may, in some embodiments, ascertain a confidence in its object classification. As mentioned hereinabove, the classification process relies on distance metrics, e.g. the Mahalanobis distance, in an embedded space. Unlike conventional methods, object classification confidence can be obtained by the human-machine three-dimensional object annotation system 200 via local density estimation (obtained in object localization as detailed hereinabove).

Using the Euclidean distance between a point's embedded space and its k nearest neighbors in a ground truth set, the human-machine three-dimensional object annotation system 200 can construct a probability space. This probability space enables the human-machine three-dimensional object annotation system 200 to estimate the likelihood of two objects sharing a class.

In some embodiments, the human-machine three-dimensional annotation system 200 may calculate a confidence score for an object N by summing the exponential of negative distances where the class of object N matches the class of objects in its k-nearest neighbors. The sum may then be normalized by dividing by the sum of exponential distances for all k-nearest neighbors. This process ensures that the confidence score is directly related to the probability of an object belonging to a specific class, providing a reliable measure of classification certainty.

As one of skill in the art understands, other methods of evaluating a prediction confidence are possible and contemplated in this disclosure.

### D. Exemplar Object Search

In some embodiments according to the present disclosure, the human-machine three-dimensional object annotation system 200 provides for exemplar search, which enables batch labeling and thereby simplifies and streamlines the annotation process. As shown in the exemplar object search flowchart 1200, exemplar object search includes (1) clustering unknown objects based on their point clouds 1202, (2) selecting an object 1204, (3) searching for the cluster class 1206, (4) return a predetermined number of potential class matches 1208, (5) receiving a confirmation or denial from a human of one or more potential class matches 1210, (6) re-clustering based on said human confirmation or denial 1212, and (7) batch labeling objects 1214.

i. Clustering Unknown Objects

As discussed hereinabove, the human-machine three-dimensional object annotation system 200, in certain embodiments, clusters unknown objects into groups using, for example, the K-medoids algorithm (or other clustering algorithms), based on their object point clouds. This step creates groups of similar objects, enabling rapid searches for similar objects. By grouping similar objects together, the human-machine three-dimensional object annotation system 200 empowers users to quickly identify all objects that share similarities. As a result, the time investment for object classification and annotation may be substantially reduced.

ii. Selecting an Object

The exemplar search begins when a user selects an object representing an object class they wish to search. This selection can be done by creating a new annotation or by choosing or editing an existing predicted annotation, such as the predictions 1002, 1004.

iii. Finding the Cluster Exemplar

Once the user selects an object, the human-machine three-dimensional object annotation system 200 can search for the cluster class of that object based on the K-medoids clustering, or other clustering algorithms known in the art. It then can identify the “cluster exemplar” 1302 (shown in FIG. 13 and discussed in more detail below) for that cluster class, a representative object generated during the clustering process.

iv. Returning Top Matches

With the cluster exemplar 1302, the human-machine three-dimensional object annotation system 200 can return the top X matches 1300, as shown in FIG. 13, for that unknown class cluster based on minimal distance. This powerful search capability empowers users to quickly access and review potential matches, significantly speeding up the annotation process.

v. User Confirmation or Denial

As depicted in FIG. 13, in some embodiments, users can then review the returned matches and either confirm (e.g. chairs 1304a, 1304b, 1304c) or deny (e.g. table 1306 and SUV 1308) their inclusion in the object class. This interactive step ensures that users have control over the labeling process.

vi. Re-Clustering Based on User Feedback

Based on user feedback for class inclusion, the human-machine three-dimensional object annotation system 200 can, in some embodiments, dynamically re-cluster object classes, refining the representation of each class and potentially improving future exemplar searches.

vii. Batch Labeling Process

As this process is repeated, object class clusters become more representative of their respective class. Once a user is satisfied with the representation, he or she can label all associated objects as the same object in a batch process.

### E. Model Transitioning

While the human-machine three-dimensional object annotation system 200 provides significant flexibility through few-shot learning, the human-machine three-dimensional object annotation system 200 may, in some embodiments, also include a model transitioning process, whereby it may seamlessly transition from few-shot learning to a more traditional machine learning model.

i. Constructing a Traditional Object Detection Model

First, the human-machine three-dimensional object annotation system 200 constructs a traditional object detection model. In some embodiments, the human-machine three-dimensional object annotation system 200 builds upon the foundation of a pre-trained model, such as a RetinaNet model, then tailoring and expanding the model to accommodate 3D objects.

ii. Transfer Learning with Limited Annotated Dataset

With an annotated 3D object dataset obtained via object localization and classification, as discussed hereinabove, the human-machine three-dimensional object annotation system 200 can transfer learning with the traditional model. This transfer learning process provides the model with valuable insights and enables it to adapt to the 3D environment.

iii. Incremental Data Addition and Further Transfer Learning

The human-machine three-dimensional object annotation system 200 continually evolves as it receives new data. At user-specified intervals, the human-machine three-dimensional object annotation system 200, in some embodiments, adds human expert confirmed instances of new object classes to the training dataset. The model can then undergo further transfer learning with this additional data, thereby increasing the accuracy with which it can recognize new object classes.

iv. Achieving User-Specified Accuracy

The above-described transition process may culminate upon achieving user-specified accuracy for new object classes. Once the human-machine three-dimensional object annotation system 200 attains a desired level of accuracy for a particular object class, that class can be removed from few-shot learning, confidently embracing the traditional model for increased accuracy and reducing the need for human intervention.

The various exemplary inventive embodiments described herein are intended to be merely illustrative of the principles underlying the inventive concept. It is therefore contemplated that various modifications of the disclosed embodiments will without departing from the inventive spirit and scope be apparent to persons of ordinary skill in the art. They are not intended to limit the various exemplary inventive embodiments to any precise form described. Other variations and inventive embodiments are possible in light of the above teachings, and it is not intended that the inventive scope be limited by this specification, but rather by the claims following herein.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above. Moreover, it is contemplated that combinations of features, elements, and steps from the appended claims may be combined with one another as if the claims had been written in multiple dependent form and depended from all prior claims. Combination of the various devices, components, and steps described above and in the appended claims are within the scope of this disclosure. The foregoing is intended to cover all modifications and alternative constructions falling within the spirit and scope of the invention.

I claim:

1. A method of identifying three-dimensional objects located inside an article comprising:
generating a scan of said article and said objects, said objects having characteristics;
identifying density centers of said objects;
localizing said objects using said density centers to determine where said objects are within said article and generate localized objects; and
classifying said localized objects, wherein said classifying step comprises the step of outputting an estimated annotation of the characteristics of said localized objects.

2. The method of claim 1, wherein the step of generating a scan of said article and said objects comprises obtaining one or more voxels.

3. The method of claim 2, wherein the step of identifying density centers of objects is followed by the steps of:
transforming said one or more voxels into a density graph; and
performing a connected components analysis on said density graph.

4. The method of claim 3, wherein the step of performing a connected components analysis on said density graph is followed by the step of creating parent-child relationships among said objects based on said connected components analysis.

5. The method of claim 4, wherein the step of creating parent-child relationships is followed by the step of creating object meshes and building scenes.

6. The method of claim 5, wherein the step of creating object meshes and building scenes is followed by the step of voxelizing said objects to create object voxelizations.

7. The method of claim 1, wherein the step of obtaining density centers of said objects further comprises the steps of:
applying a density filter; and
applying the Density-Based Spatial Clustering of Applications with Noise algorithm to identify objects having a threshold density.

8. The method of claim 7, wherein the step of classifying said localized objects further comprises the step of:
generating point clouds from said object voxelizations.

9. The method of claim 8, wherein the step of classifying said localized objects further comprises the steps of:
preparing a few-shot model having a dataset by taking the head off a PointNet dataset;
applying said few-shot model to said point clouds to obtain feature vectors.

10. The method of claim 9, wherein the step of applying said few-shot model to said point clouds to obtain feature vectors is followed by the step of:
applying a distance algorithm to ascertain the distance between said feature vectors and the feature vectors of one or more objects contained in said dataset.

11. The method of claim 1 further comprising the step of:
determining the confidence of said classifying.

12. A method of locating objects in three-dimensional space comprising:
scanning one or more objects to obtain an array of density values of said one or more objects;
identifying one or more density centers in said one or more objects; and
performing a connected components analysis, using said one or more density centers as seeds.

13. The method of claim 12 wherein the step of locating one or more density centers comprises the steps of:
applying a density filter to said array obtain a filtered array;
normalizing said filtered array; and
applying the Density-Based Spatial Clustering of Applications with Noise algorithm to said filtered array.

14. A three-dimensional human-machine paired annotation system comprising:
a scanner configured to generate a scan of three-dimensional objects having characteristics;
a non-transitory computer-readable storage medium storing instructions which, when executed by one or more processors, cause performance of operations comprising:
localizing said objects;
classifying said objects; and
outputting an estimated annotation of said objects; and
one or more processors configured to carry out the instructions stored on said non-transitory computer-readable storage medium.

15. The system of claim 14 wherein said estimated annotation of said objects is in a human-readable format.

16. The system of claim 14, wherein said operation of localizing said objects comprises:
generating point clouds of said objects;
generating feature vectors of said objects; and
performing a distance-based feature classification.

17. The system of claim 16 wherein said operations further comprise:
providing exemplar object search.

18. The system of claim 17 wherein said exemplar object search operation comprises:
clustering unknown objects into cluster classes based on said point clouds;
selecting one of said objects; and
returning a predetermined number of potential class matches.

19. The system of claim 17, wherein said step of returning a predetermined number of potential class matches is followed by the steps of:
receiving a confirmation or denial of one or more of said potential class matches; and
re-clustering based on said confirmation or denial.

20. The system of claim 17, wherein said step of re-clustering based on said confirmation or denial is followed by the step of batch labeling said objects.
